(19) United States
(12) Patent Application Publication
(10) Pub. No.: US 2010/0068523 A1
(43) Pub. Date: Mar. 18, 2010

(54) Surface modification of and dispersion of particles

(75) Inventors: Errol Williams, Minneapolis, MN (US); Christopher J. Rueb, St. Paul, MN (US); William A. Hendrickson, Stillwater, MN (US); Paul J. Verbanac, Mounds View, MN (US); Robert G. Bowman, Woodbury, MN (US)

Correspondence Address: Mark A. Litman & Associates, P.A.;York Business Center, Suite 205, 3209 West 76th St., Edina, MN, 55435, US

(73) Assignee: Aveka, Incorporated

(21) Appl. No.: 12/283,865

(22) Filed: Sep. 16, 2008

(51) Int. Cl. B05D 7/00; B32B 5/16

(52) U.S. Cl. 428/403; 427/212

(57) ABSTRACT

A method provides a redispersible nanoparticle powder. The method includes:
a) providing within a liquid carrier a first dispersion of nanoparticles having surface hydroxyl groups;
b) adding a non-metal-ester molecular reactant for the hydroxyl group into the liquid carrier;
c) reacting the reactant with the hydroxyl group to form individual, non-continuous sites having reaction product of the hydroxyl group and the reactant to form a surface treated nanoparticle; and
d) drying the surface treated nanoparticle to at least reduce the presence of any excess non-metal-ester molecular reactant and providing non-aggregated powder of the surface treated nanoparticles such that when the dried, treated nanoparticle powder is redispersed as a second dispersion in a carrier or solvent having affinity for the non-metal-ester reactant product, a nano-sized particle is formed.

### BACKGROUND OF THE INVENTION

1. Field of the Invention

The present invention relates to the field of particles, particularly colloidal size particles in the nano-scale range, the control of surface properties in particles, and the dispersion of treated particles into compositions.

2. Background of the Art

Nanotechnology is a generic field of technology that has been rapidly developing in the 21^{st} century. The scope of nanotechnology includes the manufacture and use of any material, composition or article that has maximum dimensions in the nanometer size range, which maximum dimension is typically in the range of between 1 nanometer to less than 1000 nanometers (nm), but usually is less than 500 nm and preferably less than 100 nm. Such technology includes particles, tubes, shaped materials, and actual working mechanical and/or electromechanical or electronic devices. The size of the elements of this technology has realized some of the intended benefits of functionality on a smaller dimensional scale, greater reactivity, improved site specificity and economy of material use.

One of the difficulties in the incorporation of nanotechnology into existing technology is the need to assure introduction of actual nano-size materials into the more macroscopic working environment. This is particularly true where nanoparticles are to be distributed within a macrodeposited composition such as coatings, dispersed media, reactive (electrical or electromagnetic) or active coating, and the like. A number of U.S. patents have defined the provision of surface coatings on nanoparticles (or other particles) to assist in their increased compatibility with media into which the particles are to be added. Such patents include U.S. Pat. Nos. 6,899,948; 6,467,897; 6,387,981; 6,045,650; 4,534,929; and 4,522,058. These patents usually described the application of solid coating layers over particles, especially coatings derived from silanes. U.S. Pat. No. 6,045,650 describes applying a solid coating onto a surface of an article, said surface of an article having a first physical property measurable as a degree of hydrophobicity and/or hydrophilicity, applying a liquid coating of an oxidizable material containing at least one element other than carbon, hydrogen, oxygen and nitrogen onto the surface of said article, oxidizing said oxidizable material so as to attach a material having said at least one element other than carbon, oxygen, nitrogen and hydrogen onto said surface, and thereby changing said first physical property with respect to its hydrophobicity and/or hydrophilicity. These particles are on the order of micron-size particles and greater, especially pigments. This reference is silent on the ability of using specific methodologies and the specific products to redisperse silica into nano-sized particles or the original nanoparticle size in an appropriate solvent.

Surface modification of metal oxides is not a new concept. Most treatments involve the reaction of the surface with reactive materials and forming a relatively uniform coating on the surface. The reactant is most often a silane or related material (titanate, zirconate, etc. as shown in U.S. Pat. No. 6,045,650. The present process and resulting product formed by drying the surface modified particles (having a discontinuous coating, or even extended molecular hairs radiating from the surface) to a powder (particle) and then redispersing the surface treated particles in an appropriate (having similar polar or non-polar or oleophilic/hydrophobic properties) solvent, back into nano-sized particles or articles of the original primary particle format and approximately same size particles in the format (the size increased slightly by the reacted material) is a new concept and invention.

U.S. Pat. No. 7,327,039 (Charles et al.) provides electronic articles and methods of making those articles. The electronic articles comprise an electronic component bonded and electrically connected to a substrate using an underfill adhesive comprising the reaction product of a thermosetting resin, curing catalyst, and surface-treated nanoparticles that are substantially spherical, non-agglomerated, amorphous, and solid. This reference describes the use of surface treated nanoparticles in an electronic assembly. This reference describes the nanoparticles as suitable for use in a composition of an electronic assembly of this invention as having an average particle diameter in the range of from about 1 nanometer to less than 1 micrometer. This reference describes how silica surfaces can be modified through the use of preferably organosilanes. The teaching also describes the use of alcohols to generate surface modified particles and is incorporated herein. While this patent does describe using silica sols having a starting size of about 123 nanometers, after the washing and drying process the resultant material was a powder described as “small agglomerates, of silica particles have a coating of silane coupling agent thereon and whose starting diameter was approximately 123 nanometers.” This reference is silent on the ability of using this method to redisperse silica into nano-sized particles or the original nanoparticle size in an appropriate solvent, as defined herein.

Biochemically functionalized silica nanoparticles, Monde Qhobosheane, Swadeshmukul Santra, Peng Zhang and Weihong Tan Analyst, 2001, 126, 1274-1278. In this report, is demonstrated the biochemical modification of silica based nanoparticles. Both pure and dye-doped silica nanoparticles were prepared, and their surfaces were modified with enzymes and biocompatible chemical reagents that allow them to function as biosensors and biomarkers. The nanoparticles produced in this work are uniform in size with a 1.6% relative standard deviation. They have a pure silica surface and can thus be modified easily with many biomolecules for added biochemical functionality. Specifically, they have modified the nanoparticle surfaces with enzyme molecules (glutamate dehydrogenase (GDH) and lactate dehydrogenase (LDH)) and a biocompatible reagent for cell membrane staining. Experimental results show that the silica nanoparticles are a good biocompatible solid support for enzyme immobilization. The immobilized enzyme molecules on the nanoparticle surface have shown enzymatic activity in their respective enzymatic reactions. The nanoparticle surface biochemical functionalization demonstrates the feasibility of using nanoparticles for biosensing and biomarking applications. This reference does not describe redispersing silica into nano-sized particles or the original nanoparticle size in an appropriate solvent.

Green Nanocomposites from Renewable Resources: Biodegradable Plant Oil-Silica Hybrid Coatings, Takashi Tsujimoto, Hiroshi Uyama, Shiro Kobayashi; Macromolecular Rapid Communications, Volume 24, Issue 12, Pp 711-714. Green nanocomposite coatings based on renewable plant oils have been developed. An acid-catalyzed curing of epoxidized plant oils with 3-glycidoxypropyltrimethoxysilane produced transparent nanocomposites. The hardness and mechanical strength improved by incorporating the silica network into the organic polymer matrix, and good flexibility was observed in the nanocomposite. The nanocomposites showed high biodegradability.

New multi-phase catalytic systems based on tin compounds active for vegetable oil transesterification reaction Frederique R. Abreu, Melquizedeque B. Alves, Caio C. S. Macêdo, Luiz F. Zara and Paulo A. Z. Suarez' J. Molecular Catalysis A: Chemical 227, 1-2, 2005, p263-7 Abstract: Attempts are made to develop a multi-phase catalytic system active for vegetable oil alcoholysis based upon tin compounds. The immobilization of Sn(3-hydroxy-2-methyl-4-pyrone)₂(H₂O)₂ by dissolving it in the 1-butyl-3-methylimidazolium hexafluorophosphate ionic liquid and supporting it in an ion-exchange resin, as well as the catalytic behavior of tin oxide was studied. By anchoring the tin complex in the ionic liquid, it was observed that its catalytic activity was maintained but it was not possible to reuse the catalytic system due to leaching of the catalyst from the ionic phase during each reaction. On the other hand, it was found that the tin complex lost its catalytic activity when supported in the organic resin. It was also shown that tin oxide was active for soybean oil methanolysis (conversion yields up to 93% in 3 h were achieved) and was also possible to recycle it without any loss in its catalytic activity. New multi-phase systems based on tin oxide and the complex Sn(3-hydroxy-2-methyl-4-pyrone)₂(H₂O)₂ immobilized in the 1-butil-3-methylimidazolium hexafluorophosphate ionic liquid or supported it in an ion exchange resin, are shown to be active for soybean methanolysis.

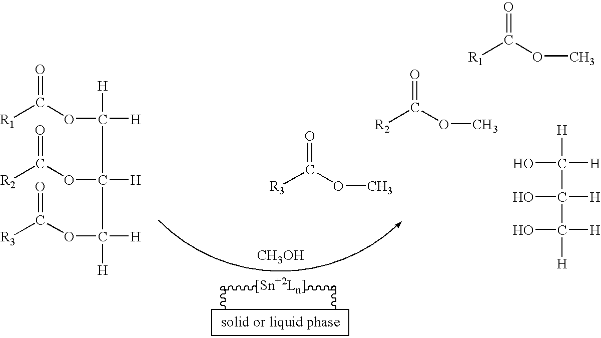

This reference describes immobilizing materials onto solid supports for use in the methanolysis of tri-glycerides.

“The Chemistry of Silica”, Ralph K. Iler; 1979, John Wiley & Sons, Inc. This reference is incorporated in full. Chapter 6 sub-section: Surface Esters with Alcohols (page 689 ff). describes the reaction of alcohols with the surface hydroxyl groups of silica.

WO 88/00860 Bonded Chromatographic Stationary Phase; Simpson and Khong; Feb. 11, 1988. This reference discloses an organic compound is bonded to a powdered solid support to produce, for example, a chromatographic stationary phase, by introducing to a bed of the powdered material the vapour of a precursor of the compound to be bonded which precursor is selected from those which produce a gas phase by-product of the bonding reaction. The gas generated by the reaction is utilised as the fluidising gas. This permits the use of fluidised bed techniques on extremely low particle size powders. One example is the reaction of alkylchlorosilanes with silica gel to produce stationary phases with bonded carbon chains, derived from the alkyl groups, of up to 24 carbon atoms. A second feature of the method is the hydrothermal pretreatment of the bed of powder with steam to precondition the support. This reference describes binding organic compounds onto solid supports for use as a chromatographic stationary phase.

J. David Sunseri, Synthetic Strategies to improve Silica-based Stationary Phases for Reversed-Phase Liquid Chromatography; 2003, Dissertation at The Florida State University. Reversed-phase liquid chromatography (RPLC) is the most popular analytical technique for separating complex mixtures. The most common stationary phases used are octadecyldimethyl (C18) phases with silica as the solid support. Although silica is the most widely used support, it is not without problems. Silica-based stationary phases have been under investigation since they were first produced in the late 1970s, and studies still continue to try to improve the phases. Silica has a small pH range (3-8) where mixtures can be separated without degradation of the column performance. Above a pH of 8, silica supports dissolve and destroy the column. Below pH 3, the silicon-carbon bond is cleaved, and the column is destroyed. Also, the silica surface has 8 μmol/m² of reactive silanols for covalent bonding with an alkylsilane. Unfortunately, due to steric hindrance, only about 45% of the silanols can be covalently bound. The remaining silanols left on the surface after derivatization are deleterious to the separation of basic solutes. This dissertation describes the investigation of improving silica-based stationary phases for reversed-phase liquid chromatography. This work focuses on the synthetic methods used to decrease silanol activity and increase pH stability through the removal of silanols or by increasing the bonding density of reversed-phase stationary phases. The use of dihydroxylation to remove silanols was investigated. Dehydroxylation is the removal of silanols to form stable siloxane bonds, which happens thermally above ˜400° C. The useful temperature range is from ˜400-800° C. Above 800° C., the silica surface sinters (melts) to reduce the surface area and becomes chromatographically useless. These phases were characterized using ²⁹Si crosspolarization magic angle spinning solid-state NMR (²⁹Si CP-MAS) and diffuse reflectance infrared Fourier Transform Spectroscopy (DRIFTS), along with liquid chromatography. Dehydroxylation was shown to decrease silanol activity and increase pH stability. Using the traditional reaction scheme of monosilane coupling chemistry, four parameters of the reaction were investigated to improve the silica stationary phase. A solvent and base study were performed to increase the bonding density of C18 silica stationary phases. A number of different solvents and bases were used to study the effect on bonding density. It was found that solvents with high dielectric constants or halogenated solvents yielded higher bonding densities than other solvents, and 4-dimethylaminopyridine (4-DMAP) was the best base or acid scavenger. Monofunctional silane coupling chemistry was done under reflux and ultrasound driving forces. It was observed that ultrasound increases the bonding density of C18 chains to the silica surface in every case over reflux conditions. Lastly, the effect of the leaving group on trimethylsilanes was investigated to see the effect on the overall bonding density of a trimethylsilane to the silica surface. The results showed that the use of halogenated monofunctional silanes, yield higher bonding densities than any other leaving groups. The order of reactivity was iodine, bromine, and chlorine. The high reactivity of the bromo and iodo leaving groups counteracts the effects of steric hindrance seen when using chlorosilanes in the bonding reaction. This work lays the groundwork for longer chain bromo and iodo silanes to be attached to the silica surface. A new reaction scheme was investigated using a chlorination-methylation scheme. The silica surface was chlorinated with pure, dry thionyl chloride, and then reacted with methyllithium. Both steps of the reaction were done under vacuum using Schlenk techniques. The reaction with methyllithium forms covalent Si—CH₃ bonds, which are very stable. The smaller CH₃ ligands have less steric hindrance than the larger Si(CH₃)₃ ligands. The new “C1” phases were investigated using ²⁹Si CP-MAS solid-state NMR and DRIFTS. Liquid chromatography was employed to check for silanol activity and pH stability. The silanol activity was greatly decreased, and the pH stability was greatly enhanced with no silica dissolution. Again, this study has laid the groundwork for longer chain alkyllithiums to be attached to the surface. This reference describes binding organic compounds onto solid supports for use as a chromatographic stationary phase.

U.S. Pat. No. 5,928,723 (Koehlert et al.) describes a process for producing surface modified metal oxide and/or organo-metal oxide compositions comprising esterifying at least a portion of the metal oxide and/or organo-metal oxide composition through contact with at least one esterification agent and at least one catalyst wherein the esterification agent and the catalyst are in the liquid phase. The process may be utilized to produce hydrophobic metal oxide and/or organo-metal oxide compositions at ambient temperature and/or ambient pressure conditions. This reference describes the reaction of an alcohol with silica (titania, alumina) surface and the use of a catalyst to enhance the reaction with the surface.

WO82/02414 Hydrophobic silica or silicate compositions for containing the same and methods for making and using the same; Maloney, Oakes. Jul. 22, 1982.A silicon defoamer comprising silica or silicate made hydrophobic by treatment with a hydrophobic alcohol at a temperature above 100° C. until the silica and the hydrophobic alcohol react, and the use of a defoaming composition comprising said silicon defoamer and a non aqueous liquid carrier. This reference describes the reaction of an alcohol with a precipitated silica or fumed silica surface and the use of these materials as anti-foaming agents. The optimal particle sizes were from about 30-60 micrometers, although the entire range of 5-100 micrometers was considered to exhibit defoaming activity; this size range is significantly larger than nanoparticle work described herein.

U.S. Pat. No. 4,534,929 (Ponjee, Verijlen) describes a matrix having a surface of silica glass which is suitable for the manufacture of articles of synthetic resin in which the surface of the matrix comprises a monolayer of an aliphatic alcohol, as well as a method of manufacturing articles having a surface of synthetic resin while using the matrix. This reference describes the reaction of an alcohol (hexadecyl) with silica glass surface (ultrasmooth surface).

EPO 799 641 A 2 Functional surfaces for chemical reactions and process for the preparation thereof, Iiskola, Suntola; Oct. 8, 1997.The invention concerns a solid phase surface structure and a process for preparing such a structure. The surface structure comprises functional groups on the surface of a substrate. The species of a reactant fed in gas or liquid phase is bound at least temporarily to the functional groups due to the interaction between said species and the functional group during a chemical reaction. According to the invention essentially all of the functional groups are attached to the substrate via a bridging group bound to the surface atoms of the substrate, the surface binding sites being so far from the surface of the substrate that the surface of the substrate does not have any significant influence on the interaction between the surface binding sites and the reactant species. The functionalized surface structures can be provided by reacting an inorganic oxide support with a compound or formula (I) R¹AX¹ wherein A is silicon, tin, germanium or carbon, R¹ is a hydrocarbon group and X¹ is a functional group. The reaction between the support and the compound of formula I is carried out under surface bond selective conditions and the reaction is continued until essentially all of the hydroxyl groups of the inorganic surface have reacted under surface bond selective conditions. By means of the invention functionalized surfaces are provided which can be used for chromatographic applications and as catalyst supports. This reference describes binding organic compounds (particularly diols) onto solid supports for use as a chromatographic stationary phase.

One problem with these technologies is that the limited chemistry and processing involved provides for a narrow range of properties on materials and also often provides for larger agglomeration of particles than is desired to assure full benefits of nanotechnology. This is particularly true where nanosized elements are prepared, then coated and then redispersed. The particles after coating tend to appear as and act as larger particles because of agglomeration and other accumulations issues with the coated particles.

### SUMMARY OF THE INVENTION

Nano-size inorganic particles having surface hydroxyl groups (e.g., siloxyl (—Si—OH), titanyl (—Ti—OH), zirconyl (—Zr—OH), aluminyl (—Al—OH), phosphate (—P—OH), sulfate (—S—OH), borate (—B—OH), mixed metal oxides, or mixtures of inorganic hydroxyl containing materials, etc.) or organic hydroxyl containing particles or mixed organic-inorganic particles that are surface reacted (through the hydroxyl groups, not necessarily 100%) to non-silane, non-titanate, non-zirconate groups so that the particles, after drying, form a powder which is redispersible into the particles with a nano-size distribution. The surface modification can proceed through one step or through several steps and are performed in a preferably liquid environment (although gaseous phase treatment of a highly dispersed solid particle phase or supercritical fluid environment can be used) in which the nano-size particles are generally (not necessarily 100%) dispersed.

Addition of many compounds to silica in the previous literature shows simple adsorption of large molecules onto the support. This work and ideas directs the large molecule to react with the support directly or through pretreatment of the support or the organic molecule. None of the above literature shows the use of organically treated materials to create a coated metal oxide or coated surface that can be easily redispersed in solvent after drying.

### BRIEF DESCRIPTION OF THE FIGURES

FIG. 1 shows a flow diagram of one process route for the practice of the present technology.

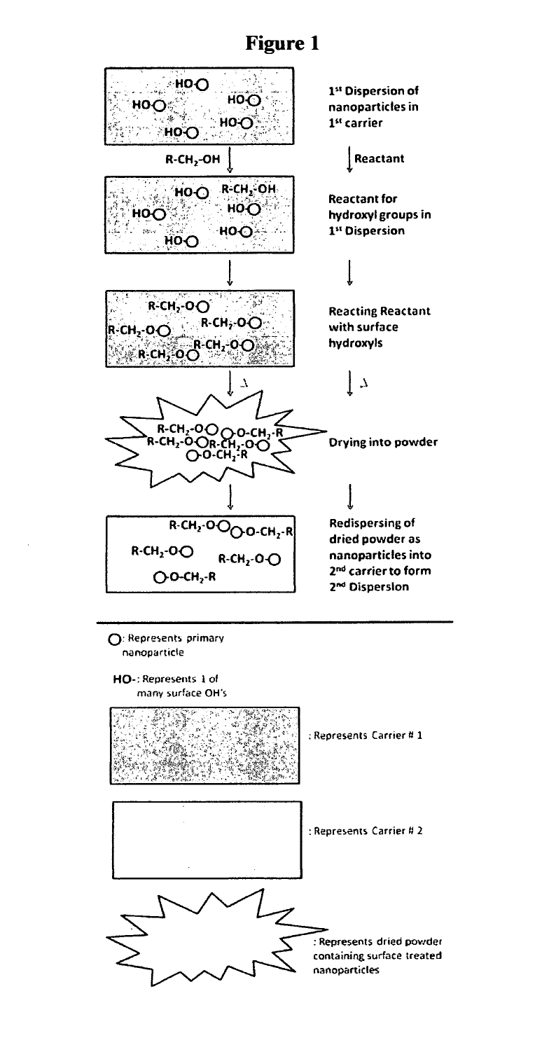

### DETAILED DESCRIPTION OF THE INVENTION

Nano-size based on either number average diameter or preferably volume or weight average diameter, less than 1000 nm, preferably less than 500 nm, more preferably less than 250 nm, most preferably less than 100 nm, still more preferably less than 10 nm and most preferably, for all maximum diameters of particles, a volume average diameter greater than 0.2 nm, inorganic particles having surface hydroxyl groups (e.g., siloxyl (—Si—OH), titanyl (—Ti—OH), zirconyl (—Zr—OH), aluminyl (—Al—OH), phosphate (—P—OH), sulfate (—S—OH), borate (—B—OH), etc.) or organic hydroxyl containing materials (e.g., polysaccharides, natural products, polymers with functional OH's, polyvinyl-alcohol, partially oxidized polymers, partially oxidized polyethylene, partially oxidized polypropylene, are surface reacted (through the hydroxyl groups) to non-ester-silane, non-ester-titanate, non-ester-zirconate groups (these materials, although inclusive of inorganic nominative atoms such as silicon for silane and titanium for titanate, are referred to herein as non-metal-ester hydroxyl reactive reagents or materials. The term non-metal-ester basically means that the compounds are reactive with surface hydroxyl groups, but not through a metal-ester (e.g., titanate, zirconate such as n-propoxytriethoxy titanate, or bis(diethylcitrato)di-n-propoxy zirconate) or inorganic ester (e.g., silane such as 3-aminopropyltriethoxysilane) so that the particles, after drying, form a powder which is redispersible into the primary particles in a nano-size distribution. The avoidance of the metal-ester groups avoids the polymerization reaction that would be probable on the surface of the particles that would cause interparticle surface reaction and permanent binding of particles into a larger size). The surface modification can proceed (not necessarily 100%) through one step or through several steps and are performed in a liquid environment (although gaseous phase treatment of a highly dispersed solid particle phase or supercritical fluid environment can be used) in which the nano-size particles are generally (not necessarily 100%) dispersed. The particles are at least partially reacted through the surface hydroxyl groups in a liquid environment, at least partially dried to form a free-flowing powder composition (when in an anhydrous or very low humidity environment), and the powder can then be redispersed into a liquid environment (retaining the nano-size particle distribution) based on the affinity (oleophilic or hydrophilic; polar or non-polar) of the surface reacted sites with a medium in the fluid. The redispersion may be enhanced with appropriate mechanical agitation or with a sonic horn or with other techniques known to those skilled in the art.

We define the size of the redispersed particle as Rₚ and the size of the primary particle as Pₚ. We define the redispersion ratio as Sₚ=Rₚ/Pₚ. For this invention it is desirable to have the redispersion ratio (Sₚ) be less than 70, preferably less than 50, even more preferably less than 30, most preferably less than 20, and still even more preferably less than 10.

Those skilled in the art know of a variety of (non-limiting) techniques that may be used to determine if redispersion has occurred: (a) a visual examination of the solvent or carrier after the redispersion of particles to see if there is an increase in the turbidity or opacity of the solvent or carrier wherein turbidity in a carrier or solvent is caused by light being scattered from the redispersed particles in the solvent or carrier; (b) using a turbidity meter or equivalent method to measure an increase in turbidity in the solvent or carrier after the redispersion of particles into the solvent or carrier; (c) a weight increase by taking a portion of the solvent or carrier containing the redispersed particles and drying it to remove the solvent and weighing the remaining residue; and/or (d) using dynamic light scattering or equivalent method and determining if there are redispersed particles. Dynamic light scattering or an equivalent method is necessary to determine that the redispersed particles have a preferably volume or weight average diameter less than 1500 nm, preferably less than 1000 nm, more preferably less than 500 nm, most preferably less than 250 nm, still more preferably less than 100 nm, and even still more preferably less than 50 nm in size.

The term particles covers regular (e.g., spherical, oval, geometric, square, rectangular, etc.) and irregular, smooth or rough shaped elements, and may be of roughly similar dimensions in particles, with various aspects having ratios of from 1:1 to 5:1, or be more dissimilar in dimensions such as fibroids, fibers and the like, with relative aspects differing by 0.5:1, and up to 20:1 or 30:1 or more. The particles may be crystalline, amorphous, or contain phases of crystalline and amorphous materials.

Redispersion of the materials depends upon a variety of (non-limiting) factors such as the composition of the core particle, the degree to which the surface hydroxyl groups have been reacted, the metal-reactant linkage polarity, the composition of the reactant moiety, the polarity of the solvent, the reactivity of the solvent or carrier with the reactant moiety, and the temperature of the solvent or carrier. Redispersion may occur when the surface treated particles are introduced into a good solvent or carrier. If a solvent is “good,” interactions between surface treatment chain segments and solvent molecules may be energetically favorable, and may cause chain segments to expand and become solvated. This condition may allow for redispersion. If a solvent activity is “poor,” chain segment—chain segment interactions may be preferred and the chain segments may remain in contact between particles preventing redispersion. The quality of the solvent or carrier depends on both the chemical compositions of the chain segments, the solvent or carrier type, and the solution or carrier temperature. If a solvent is precisely poor enough to cancel the effects of solvated chain segments, the “theta (O) condition” is satisfied. For a given chain segment-solvent or segment-carrier pair, the theta condition is satisfied at a certain temperature, called the “theta (O) temperature.” A solvent or carrier at this temperature is called a theta solvent or carrier and redispersion may also occur.

The surface modification can be accomplished through a variety of methods listed in the equations that follow. The surfaces of metal oxides contain surface hydroxyl groups or can have them introduced through steaming processes or can contain hydroxides as being a mixture of metal oxides and metal hydroxides. The representation for surface silica hydroxyl moiety will be HO—Si, for titania, HO—Ti; for zirconia, HO—Zr, for alumina, HO—Al, for phosphate, HO—P, for sulfate, HO—S, for borate, HO—B, and corresponding hydroxyl functionalities on other inorganic particles. This work can be extended to other metal oxides, metal hydroxides, metal phosphates, metal sulfates, metal borates, sulfated metal oxides, borated metal oxides, phosphated metal oxides, containing surface hydroxyl groups. The following description of the International Union of Pure and Applied Chemistry (IUPAC) Periodic Table of the Elements is referenced in http://www.iupac.org/reports/periodic table/; (a copy of which was submitted with the filing of this patent) also included as reference is NEW NOTATIONS IN THE PERIODIC TABLE, Pure & Appl. Chem., Vol. 60, No. 3, pp. 431-436, 1988. This work can be extended to the solid oxides of the metal and metalloids from groups 2-15 the 2007 International Union of Pure and Applied Chemistry (IUPAC) Periodic Table of the Elements, such metal oxides can include as alumina, titania, zirconia, magnesia, calcium oxide, strontium oxide, barium oxide, scandium oxide, yttria, hafnia, vanadium oxide, niobium oxide, tantalum oxide, chromia, molybena, tungsten oxide, manganese oxide, rhenium oxide, iron oxide, ruthenium oxide, osmium oxide, cobalt oxide, rhodium oxide, iridium oxide, nickel oxide, palladium oxide, platinum oxide, copper oxide, silver oxide, gold oxide, zinc oxide, cadmium oxide, gallium oxide, india, thalium oxide, germanium oxide, tin oxide, lead oxide, arsenic oxide, antimony oxide, bismuth oxide, lanthana, ceria, rare earth metal oxides, thoria, uranium oxide, and mixtures of oxides such as barium titanate or silico-aluminas or titanosilicates or tin-antimony oxides, etc. This work can be extended to the solid hydroxides of the metal and metalloids from groups 2-15 the 2007 International Union of Pure and Applied Chemistry (IUPAC) Periodic Table of the Elements such as magnesium hydroxide, calcium hydroxide, strontium hydroxide, barium hydroxide, scandium hydroxide, yttrium hydroxide, titanium hydroxide, zirconium hydroxide, hafnium hydroxide, vanadium hydroxide, niobium hydroxide, tantalum hydroxide, chromium hydroxide, molybdenum hydroxide, tungsten hydroxide, manganese hydroxide, rhenium hydroxide, iron hydroxide, ruthenium hydroxide, osmium hydroxide, cobalt hydroxide, rhodium hydroxide, iridium hydroxide, nickel hydroxide, palladium hydroxide, platinum hydroxide, copper hydroxide, silver hydroxide, gold hydroxide, zinc hydroxide, cadmium hydroxide, aluminum hydroxide, gallium hydroxide, indium hydroxide, thallium hydroxide, germanium hydroxide, tin hydroxide, lead hydroxide, antimony hydroxide, bismuth hydroxide, lanthanum hydroxide, cerium hydroxide, rare earth metal hydroxides, thorium hydroxide, uranium hydroxide and mixtures of hydroxides. This work can be extended to phosphates, sulfates, and borates of the metal and metalloids from groups 2-15 the 2007 International Union of Pure and Applied Chemistry (IUPAC) Periodic Table of the Elements such as calcium phosphate, zirconium phosphate, barium sulfate, sulfated zirconia, sulfated silica, phosphated silica, borated silica, metal surface hydroxides reacted with sulfur trioxide, metal surface hydroxides reacted with phosphorous pentoxide, etc. This work can be extended to oxide/hydroxide surfaces formed on carbide or nitride materials such as SiC, BN, BC, and WC. This work can be extended to metal oxides/metal hydroxides reacted onto metal oxides such as tungstates reacted on silica or molybdates reacted onto silica. This work can be extended to oxide/hydroxide coatings such as silica coating onto magnesium hydroxide or silica coatings on carbon black. This work can be extended, less preferably to other materials surface hydroxyl groups such as phenolic resins, polyvinyl alcohol, partially oxidized polyethylene, partially oxidized waxes, partially oxidized carbon blacks, partially oxidized carbon nano-tubes, partially oxidized C₆₀ species, etc. Those skilled in the art will note that not 100% of the surface hydroxyl groups may be reacted. It is also noted that it may be desirable to have less than 100% of the surface hydroxyl groups reacted. For the chlorination (or bromination) described below, those skilled in the art will note which materials can be fully chlorinated (or brominated) or are partially chlorinated (or brominated). The practice of the present technology with respect to silica will be emphasized to normalize and simplify the discussion and wording, but it must be remembered that a more generic concept (or reacting with any available hydroxyl) is being discussed and enabled and exemplified through the description of silica as the main topic.

### For Alcohols:

(1) Reacting with silica surface hydroxyls:

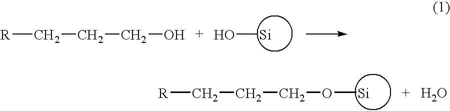

(2) Reacting the alcohol with silicon tetrachloride (silicon tetrabromide, silicon dichloride-dibromide, etc.) and then reacting with silica surface hydroxyls:

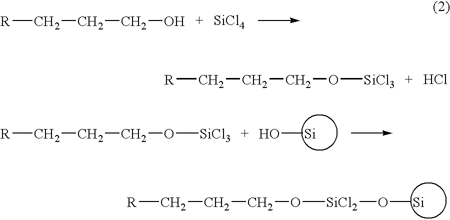

(3) Pretreating the silica with various chlorinating (halogenating) agents to generate a chlorinated (halogenated, fluoride, chloride, bromide or iodide) silica surface which can react with the alcohols:

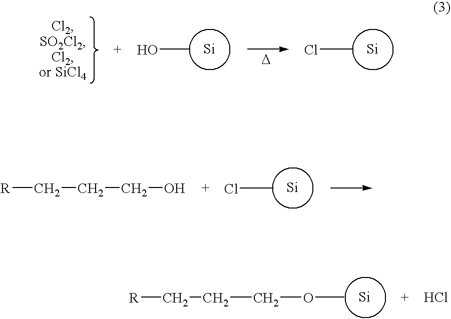

### For Organic Acids:

(4) Reacting with silica surface hydroxyls:

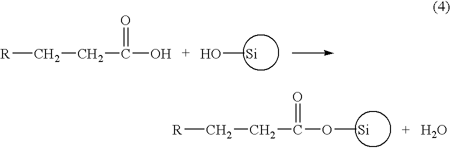

(5) Reacting the organic acid with a chlorinating agent to generate the organic acid chloride which will then react with the silica surface hydroxyls:

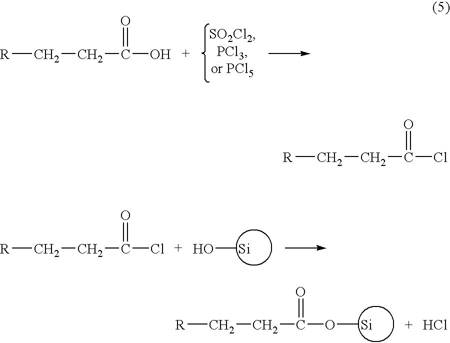

(6) Reacting the organic acid with silicon tetrachloride and then reacting with silica surface hydroxyls:

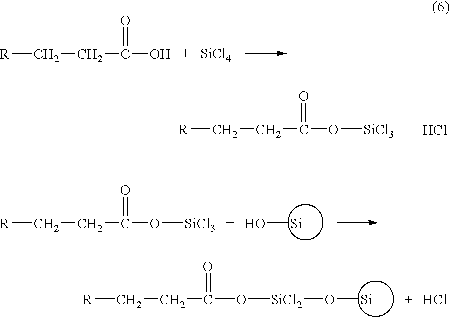

(7) Pretreating the silica with various chlorinating halogenating) agents to generate a chlorinated (halogenated) silica surface which can react with the organic acids:

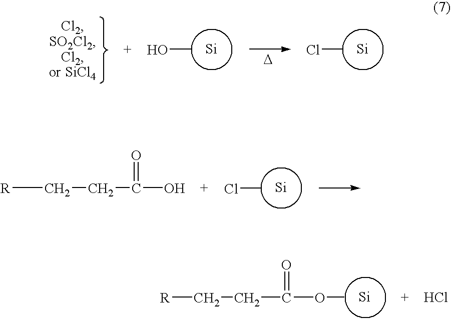

### For Esters:

(8) Reacting with silica surface hydroxyls; this can potentially lead to either a surface as in (4) above, or to a surface containing both species for (1) and (4) above:

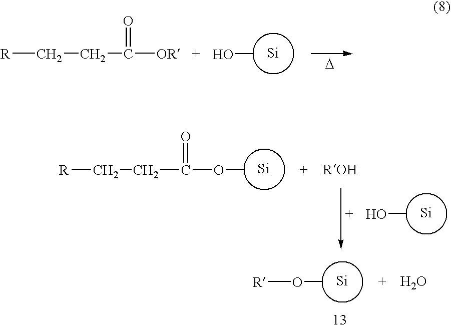

A variety of materials can be used as starting materials for treating the silica surface (especially inorganic oxide hydroxyl-containing surfaces) to generate the organo-silica material. These particles having hydroxyl-containing surfaces also include any organic nano-size materials with active hydroxide functionality, active ester functionality, active amide functionality, or active halide functionality. Such materials can include alcohols, organic acids, organic acid esters, organic acid chlorides, organic acid amides, mono-di-tri-glycerides, proteins, peptides, phytosterols, polysaccharides, amino acids, linseed oil, oleic acid, stearic acid, oleamide, sugars, etc. The material can contain multiple functionalities.

A brief look at di-glycerides (used as an example of practice with organic materials, but not intended to so limit the scope of organic materials) can show how one might react this with the surface of silica. The di-glyceride can react directly with the silica surface hydroxyl group to release water and generate the surface bound di-glyceride (as in 9-a). An alternate method (as in 9-b) is to pretreat the silica to generate the surface chloride which can react with the di-glyceride probably at a lower temperature than in 9-a. Another alternate method (as in 9-c) is to react the di-glyceride with silicon tetrachloride and the resulting material can then react with silica surface hydroxyl groups probably at a lower temperature than in 9-a.

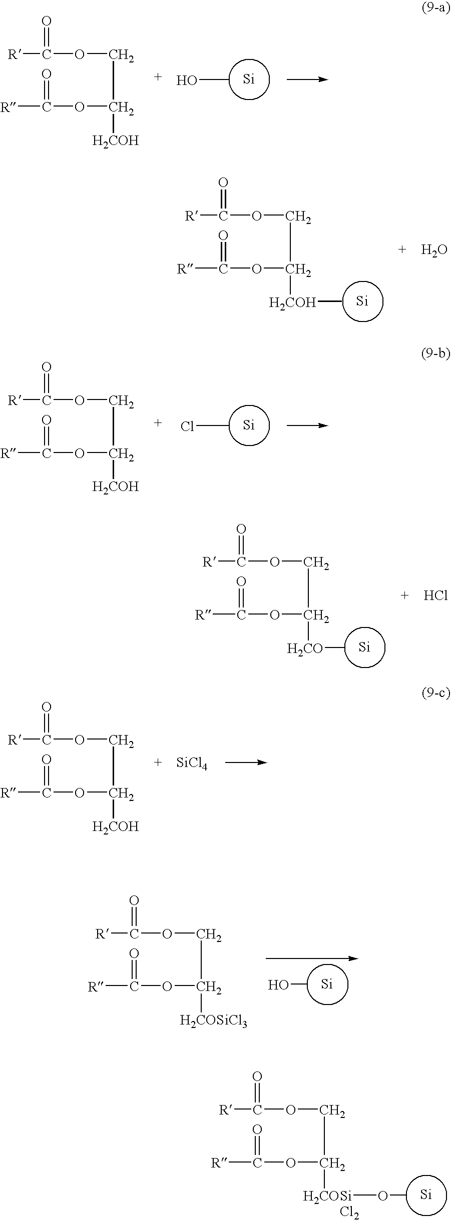

A brief look at tri-glycerides can show how one might react this with the surface of silica. The tri-glyceride can react directly with the silica surface hydroxyl group to release an organic acid and generate the surface bound di-glyceride (10). The released organic acid may then react with another silica surface hydroxyl to release water and generate a surface bound ester. This reaction generates a mixed set of surface species.

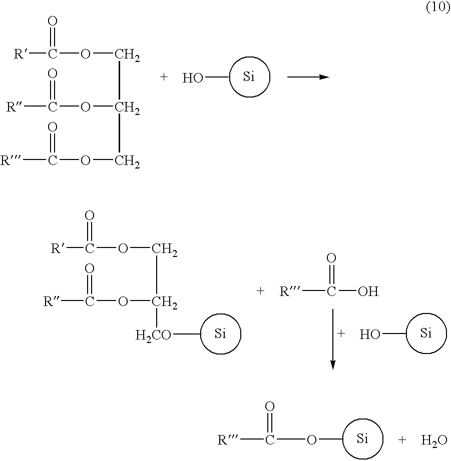

### For Generating Organosurfaces:

(11) Reacting phosphate, borate, or sulfate groups onto metal oxides/hydroxides, or metal carbides and nitrides containing surface hydroxyls, or partially oxidized polymers or partially oxidized carbon blacks, followed by reaction with alcohols, organic acids, or other materials listed hereinbefore.

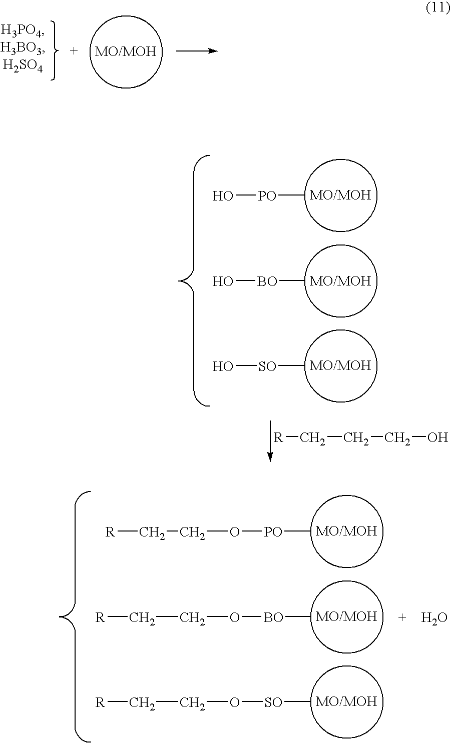

(12) Generating organophosphate, organosulfate, organoborate esters and then reacting onto metal oxides/hydroxides, or metal carbides and nitrides containing surface hydroxyls, or partially oxidized polymers or partially oxidized carbon blacks:

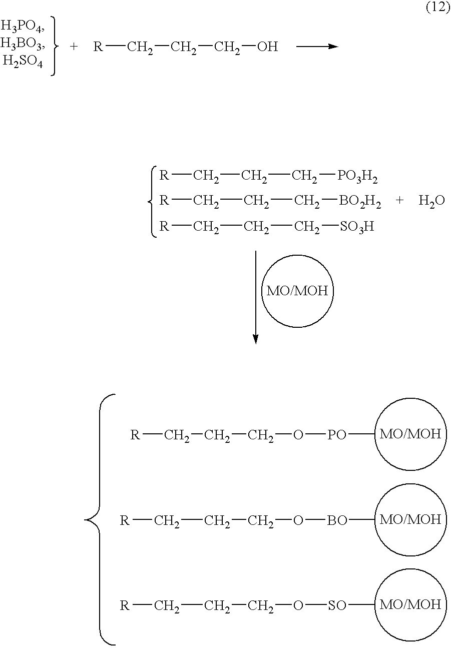

### EXAMPLE 1

Colloidal silica from Nalco (DVSZN002; colloidal silica dispersed in water) was surface modified with 1-octanol in the presence of a co-solvent (1-methoxy-2-propanol) The mixture was heated at 80° C. for a period of time (1 hour), then cooled to room temperature and spray dried at standard conditions to form smaller, free-flowing particles. The spray dried particulate material was re-dispersed in a number of solvents and the particle size as present in the dispersion determined. The initial primary particles (Pₚ) of the colloidal silica were measured to be a mean volume average particle size of 21 nm. After the surface modification and the spray drying process, the surface treated material was re-dispersed into a solvent such as butyl acrylate to yield a redispersed particle (Rₚ) with a mean volume average particle size of 276 nm. The redispersed material was nano-sized with a redispersion ratio (Sₚ) of 13.1.

2000.0 grams of the Nalco DVSZN002 was added to an 8 L stainless steel container. 2249.6 grams of the co-solvent 1-methoxy-2-propanol was mixed in with an adjustable rate air operated three pronged 4″ diameter stainless steel pitched blade mixer that was grounded to the 8 L container. A vortex was formed and 80.4 grams of 1-octanol was dripped into the mixture. The batch was heated on a hot plate to 80° C. Once the batch reached this temperature, the temperature was held constant within ±2° C. of 80° C. for 1 hour. The batch remained mixing during the heating step with aluminum foil covering the lid of the mixing tank. After the batch cooled to 60° C., the agitation was stopped and the mixing vessel was sealed with aluminum foil overnight.

For the spray drying tests, the damper on the air flow was always wide open. The pump used was a computerized drive Masterflex™ LS Model 77250-62. The pump tubing used was C-Flex L/S 15 part# 6424-15 from Cole-Parmer. The dip tube used was a 304 stainless steel 1 ft section of 3/16″ ID pipe from McMaster-Carr. The transfer tubing before and after the pump was flexible clear PVC ¼″ ID tubing from McMaster-Carr. The nozzle configuration used was a Spraying Systems ¼ JBC two fluid nozzle with part No. 60100SS as the liquid cap and an external mix flat spray air cap: Part No. 122281-60°. This configuration is least likely to plug the spray nozzle and most likely to give the smallest mean particle size based on previous experiments in this dryer. The dryer used was a lab scale electric Niro Mobile Minor.

When the feed material had cooled to ambient temperature, the mixture was clear, colorless, slightly opaque, and slightly viscous. There was no phase separation or gel that was formed in the batch. Because of this, during spray drying, the batch was not mixed, but pumped directly from the bottom of the mixing tank. Two minute calibrations of the pump were done to determine the maximum RPM the pump could be run at during drying. See the Table 1 below. The 20 RPM setting was close enough to the maximum pump rate determined by the LEL calculation. The feed material pumped was returned to the feed tank.

TABLE 1

| Pump RPM | Grams Pumped | Grams/Minute |
|---|---|---|
| 10 | 64.6 | 32.3 |
| 15 | 95.4 | 47.9 |
| 20 | 126.7 | 63.4 (MAX) |

Half of the feed described above was used for the spray drying. First deionized water at ambient temperature was used to bring the dryer to the proper outlet temperature and it was used to flush out the feed line after processing. The atomizing air pressure was 106-111 psi to minimize the particle size of the droplets formed. The inlet temperature of the dryer was initially set at 275° C. and the pump rate was set at 10 RPM to reach a steady state outlet temperature. This example run lasted about 1 hour as the feed material was pumped into the dryer at a rate of 30.9 g/min with no nozzle plugging. The 16 oz. glass collection jar on the cyclone was emptied every 30 minutes; samples collected during the processing were combined. The dryer cone and cyclone piping were tapped down every 10 minutes during the run. The outlet temperatures ranged from 70.4° C. to 81.2° C. with steady state being at 81° C.

The moisture analysis results showed that the dried material had 3.59% moisture. The thermal gravimetric analysis (TGA) showed 7-8% weight loss under 200° C.

After spray drying, samples of the dried material were placed in solvents for dispersibility testing and particle size analysis. For the visual appearance and for dynamic light scattering, 0.11 grams of spray dried powder was placed in 5.0 grams of solvent then shaken by hand. See Table 2.

### EXAMPLE 2

Half of the feed described in Example 1 were dried as described in Example 1 except the inlet temperature was decreased to 225° C. and the outlet temperature ranged from 79.7° C. to 74.5° C. with steady state being at 75° C. After flushing with DI water and cooling the dryer down. The dryer was shut down and blown down then inspected. There was no significant buildup of powder in the dryer cone or piping. The 16 oz. glass collection jar on the cyclone was emptied every 30 minutes; samples collected during the processing were combined.

The moisture analysis results showed that the dried material had 2.76% moisture. The TGA analysis showed 7-8% weight loss under 200° C.

After spray drying, samples of the dried material were placed in solvents for dispersibility testing and particle size analysis. For the visual appearance and for dynamic light scattering, 0.11 grams of spray dried powder was placed in 5.0 grams of solvent then shaken by hand. See Table 2.

19

TABLE 2

| Solvent, | *(a) Liquid Appearance | | **Sₚ |
|---|---|---|---|
| Ex. | (b) Settling Observation | Mean PSD | Pₚ = 21 nm |
| Heptane, | (a) Clear solution | Not Applicable | Not |
| Ex. 1 | (b) white precipitate on | | Applicable |
| | bottom | | |
| Heptane, | (a) Clear solution | Not Applicable | Not |
| Ex. 2 | (b) white precipitate on | | Applicable |
| | bottom | | |
| Methyl | (a) Opaque solution | 1100 nm | 47.6 |
| Methacrylate, | (b) Some sediment on | | |
| Ex. 1 | bottom with time | | |
| Methyl | (a) Opaque solution | 600 nm | 28.6 |
| Methacrylate, | (b) Some sediment on | | |
| Ex. 2 | bottom with time | | |
| Butyl | (a) Opaque solution | 276 nm | 13.1 |
| Acrylate, | (b) Some sediment on | | |
| Ex. 1 | bottom with time | | |
| Butyl | (a) Opaque solution | 342 nm | 16.3 |
| Acrylate, | (b) Some sediment on | | |
| Ex. 2 | bottom with time | | |
| 1-Octanol, | (a) Opaque solution | 600 nm | 28.6 |
| Ex. 1 | (b) Some sediment on | | |
| | bottom with time | | |
| 1-Methoxy- | (a) Opaque solution | 2200 nm | 104.8 |
| 2-Propanol, | (b) Some sediment on | | |
| Ex. 1 | bottom with time. | | |

*Clear solution may indicate that material did not redisperse in a particular solvent; opaque solution indicates redispersion occurred.
**Sₚ is the redispersion ratio and is equal to Rₚ/Pₚ wherein Rₚ is the size of the redispersed particle and Pₚ is the size of the primary particle.

The invention may be generally described as a method (and resulting product) of providing a redispersible nanoparticle powder comprising:
a) providing a first dispersion of nanoparticles having surface hydroxyl groups;
b) adding a non-metal-ester molecular reactant for the hydroxyl group into the dispersion of nanoparticles having surface hydroxyl groups;
c) reacting the reactant with the hydroxyl group to form individual, non-continuous sites having reaction product of the hydroxyl group and the reactant to form a surface treated nanoparticle; and
d) drying the surface treated nanoparticle providing a non-aggregated powder of the surface treated nanoparticles such that when the dried, treated nanoparticle powder is redispersed as a second dispersion in a carrier or solvent having affinity for the non-metal-ester reactant product, a nano-sized particle is formed.
   The drying is preferably effected by spray drying of the dispersion. The reactant is preferably selected from the group consisting of organic alcohol, organic ketones, organic acids, organic esters, and di-glycerides. The hydroxyl groups may be first reacted with halogenating agents before being combined with a reagent that will react with the halogenated hydroxyl group. The halogenating agent may be, for example, a halogenated silicon compound. The nanoparticle preferably is an inorganic metal oxide or semimetal oxide, such as at least one of silica, alumina, titania or zirconia, or mixtures thereof. Other hydroxide generating species may be added to the metal oxide or metal hydroxide to prepare surface hydroxides, such as the addition of phosphates, borates, sulfates, tungstates, or molybdates. The reaction product extends from surfaces of the nanoparticles as individual molecular entities bound to the surfaces, looking much like hairs (straight, curled, waved, etc.). The dried surface-treated nanoparticle is redispersed into a solvent or carrier such that a redispersed particle size determined by dynamic light scattering has a volume or weight average diameter less than 1000 nm. A dispersible free-flowing powder comprising nanoparticles or particles when dispersed that become nanoparticles is provided. This may be narrowly described as free-flowing nanoparticle powder having, reacted on their surface, reaction of a hydroxyl group and a reactant is selected from the group consisting of organic alcohol, organic ketones, organic acids, organic esters, and di-glycerides, the reaction product extending from surfaces of the nanoparticles as individual molecular entities bound to the surfaces and forming a discontinuous layer on the surfaces.

The redispersion ratio Sₚ (=Rₚ/Pₚ) for this invention should be less than 70, preferably less than 50, even more preferably less than 30, most preferably less than 20, and still even more preferably less than 10. The redispersed particles are preferably volume or weight average diameter less than 1500 nm, preferably less than 1000 nm, more preferably less than 500 nm, most preferably less than 250 m-n, still more preferably less than 100 min, and even still more preferably less than 50 nm in size.

### Particles Used in the Present Technology

It has been found that materials into which particles of the invention are added still possess good rheological properties. Their properties, including strength, shear properties, viscosity and the like, can be enhanced by using surface-modified surface of the particles. Surface treatment (surface-modification) enhances the dispersibility of the particles and their ability to bind into the matrix.

In a preferred embodiment where a polymeric, hardenable (by heat, radiation and/or drying) material has little to no slump, yet easily adapts to, for example, a recess, gap, groove or cavity reparation, and is easily contoured and feathered. Preferably, the hardenable materials of the invention do not stick to placement instruments (as enhanced by lubricating agents), and are advantageously, overall, fast and easy to use in mechanical/chemical procedures such as, for example, adhesion, surface coating, and repair of surface structure. The hardenable polymeric materials of the invention can possess improved and desirable shear thinning behavior. That is, they can have a low viscosity when subjected to high stress, and high viscosity when subjected to low stress. The low viscosity under high stress allows a practitioner to more facilely apply compositions to surfaces and structures over a total surface and reshape the material. Advantageously, the high viscosity under low stress allows the material to maintain its shape (i.e. no slumping) after a practitioner manipulates the material to match the contour of the surface, as in a molding repair operation.

The dry treated particle (by dry it is meant that the particles remain free-flowing without suspension in a liquid layer or with a liquid interface between particles, usually with less than 10%, preferably less than 5% evaporable liquid present, excluding any water of hydration and other bound liquids) silica is dispersed within the hardenable resin matrix. The silica particles used in the materials of the invention preferably have an average diameter of less than about 1000 nm; more preferably, the particles are less than about 500 nm, and most preferably less than 100 nm in volume average diameter for the largest dimension (e.g., in a fiber or nanotube, the length of the fiber). These measurements are preferably based on a TEM (transmission electron microscopy) method, whereby a population of is analyzed to obtain an average particle diameter. A preferred method for measuring the particle diameter is set out below, in the Test Methods section. The average surface area of the (e.g., silica) particles is preferably greater than about 15 m²/g; more preferably greater than about 30 m²/g.

Once dispersed in the resin, the silica particles are in a generally discrete (individual) and unassociated (i.e. non-agglomerated, non-aggregated) condition. “Agglomerated” as used herein, is descriptive of a weak association of particles usually held together by charge or polarity and can be broken down into smaller entities. “Aggregated,” as used herein, is descriptive of a strong association of particles often bound together by, for example, residual chemicals treatment; further breakdown of the aggregates into smaller entities is very difficult to achieve.

The silica particles used in the hardenable materials are preferably substantially spherical and substantially non-porous. Although the silica is preferably essentially pure, it may contain small amounts of stabilizing ion such as ammonium and alkaline metal ions.

Preferred nano-sized silicas are commercially available from Nalco Chemical Co. (Naperville, Ill.) under the product designation NALCO COLLOIDAL SILICAS. For example, preferred silica particles can be obtained from using NALCO products 1030, 1034A, 1040, 1042, 1050, 1060, 1115, 1130, 1140, 2326, 2327, 2329 and DVSZN002. In a preferred embodiment where the hardenable resin employs a cationic initiation system, the starting silica is preferably acidic (such as Nalco 1042). Optionally, fumed silica can be included in the materials of the invention in addition to the nano-sized silica particles described above. Suitable fumed silicas include for example, products sold under the tradename AEROSIL™ series OX-50, -130, -150, and -200 available from DeGussa AG, (Hanau, Germany), and CAB-O-SILO M5 available from Cabot Corp (Tuscola, Ill.).

Surface-treating the nano-sized silica particles before loading into the hardenable material can provide a stable dispersion in the resin. “Stable”, as used herein, means a hardenable material in which the particles do not agglomerate after standing for a period of time, such as about 24 hours, under standard ambient conditions—e.g. room temperature (about 20-22° C.), atmospheric pressure, and no extreme electromagnetic forces. Preferably, the surface-treatment stabilizes the nano-sized particles so that the particles will be well dispersed in the hardenable resin and results in a substantially homogeneous composition. Furthermore, it is preferred that the silica be modified over at least a portion of its surface with a surface treatment agent so that the stabilized particle can disperse, copolymerize or otherwise react with the hardenable resin during curing.

The silica particles of the present invention are preferably treated with a resin-compatibilizing surface treatment agent. Particularly preferred surface treatment or surface modifying agents excluding silane, titanate, and zirconate (metal esters) treatment agents capable of polymerizing with a resin. Specifically excluded are reactive and bifunctional silane treatment agents including .gamma.-methacryloxypropyltrimethoxysilane, and .gamma.-glycidoxypropyltrimethoxy silane.

Upon surface treating the silica particles, they can then be combined with an appropriate hardenable resin to form a material of the invention. The silica particles are preferably present in amounts greater than about 2%, greater than 10 percent or at least 40 weight percent (wt. %) of the total weight of the material. More preferably, the silica particles are present in an amount of about 40 wt % to about 90 wt %; most preferably, the silica particles are present in an amount of about 50 wt % to about 75 wt %.

Heavy metal oxide components (for radiopacity), flexibilizing agents, thickening agents, dyes, pigments, antioxidants, UV absorbers, texturizing agents, conductive materials, as well as other additives, may be included in the hardenable materials of the invention in various forms, including for example, particles on the silica surface or amongst the silica particles, or a coating on at least a portion of the surface of a silica particle. Preferably, the heavy metal oxide component is provided as a sol or individual particles blended with the surface-treated particles.

Another preferred zirconia sol for use in providing treated particles according to the present technology is disclosed by Kolb in U.S. patent application Ser. No. 09/428,374, entitled “Zirconia Sol and Method of Making Same.” and which is incorporated herein. Zirconia sols of application Ser. No. 09/428,374 comprise a plurality of single crystal zirconia particles having an average primary particle size of about 20 nm or less, more preferably, having an average primary particle size ranging from about 7-20 nm. As used herein, the term “primary particle size” refers to the size of a non-associated single crystal zirconia particle. Primary particle size is determined by the test method entitled, Crystallite Particle Size and Crystal Form Content, a procedure which resides in the Test Methods section below.

As disclosed in application Ser. No. 09/428,374 the zirconia sols comprise zirconia particles which are highly crystalline in nature. This is important in that crystalline zirconia has a higher refractive index and higher x-ray scattering capability than amorphous zirconia. Crystallinity of zirconia particles may be quantified, for example, using a crystallinity index. Crystallinity index is calculated by dividing the x-ray scattering intensity of the sample material by the x-ray scattering intensity of a known crystalline standard material, for example, calcium stabilized zirconium oxide. A specific test procedure for determining the crystallinity index of zirconia particles is entitled Crystallinity Index Procedure, a description of which resides in the Test Methods section below. In the zirconia sols, the zirconia particles have a crystallinity index of about 0.65 or greater. More preferably, the zirconia particles having a crystallinity index of about 0.75 or greater, most preferably about 0.85 or greater.

Of the crystalline portion of the zirconia particles, the predominate crystal lattice forms are cubic and tetragonal with a minor amount of monoclinic phase also being present. Due to the difficulty in separately quantifying cubic and tetragonal crystal lattice structures using x-ray diffraction, the two have been combined and are reported herein as combined cubic and tetragonal. Specifically, the zirconia particles comprise about 70% or greater combined cubic and tetragonal crystal lattice structure. More preferably, the zirconia particles comprise about 75% or greater combined cubic and tetragonal crystal lattice structure, and most preferably comprise about 85% or greater combined cubic and tetragonal crystal lattice structure. In each instance, the balance of the crystalline phase is in the monoclinic crystal lattice structure.

Due to their very small size, the zirconia particles exist in predominately cubic and tetragonal crystal lattice phases without need for an effective amount of a crystal phase stabilizer. As used herein the term “crystal phase stabilizer” refers to a material which may be added to stabilize zirconia in the cubic and/or tetragonal crystal lattice structure. Specifically, crystal phase stabilizers function to suppress transformation from the cubic and/or tetragonal phase to the monoclinic phase. Crystal phase stabilizers include, for example, alkaline-earth oxides such as MgO and CaO, rare earth oxides (i.e., lanthanides) and Y₂O₃ “An effective amount” refers to the amount of crystal phase stabilizer necessary to suppress transformation of zirconia from the cubic and/or tetragonal phase to the monoclinic phase. In a preferred embodiment, the zirconia particles comprise less than about 1 wt. % of a crystal phase stabilizer, more preferably less than about 0.1 wt. % of a crystal phase stabilizer.

In zirconia sols of application Ser. No. 09/428,374, the primary particles of zirconia exist in a substantially non-associated (i.e., non-aggregated and non-agglomerated) form. A quantitative measure of the degree of association between the primary particles in the sol is the dispersion index. As used herein the “dispersion index” is defined as the hydrodynamic particle size divided by the primary particle size. The primary particle size is determined using x-ray diffraction techniques as described in the test procedure “Crystallite Particle Size and Crystal Form Content” set out below, and which Test Methods are explained in greater detail in U.S. Pat. No. 6,899,948 (which is incorporated herein in its entirety, by reference). Hydrodynamic particle size refers to the weight average particle size of the zirconia particles in the aqueous phase as measured by Photon Correlation Spectroscopy (PCS), a description of which resides in the Test Methods section below. If the primary particles are associated, PCS provides a measure of the size of the aggregates and/or agglomerates of primary particles in the zirconia sol. If the particles are non-associated, PCS provides a measure of the size of the primary particles. Accordingly, as the association between primary particles in the sol decreases the dispersion index approaches a value of 1. In the zirconia sols, the primary zirconia particles exist in a substantially non-associated form resulting in a zirconia sol having a dispersion index ranging from about 1-3, more preferably ranging from about 1-2.5, and most preferably ranging from about 1-2.

### Test Methods

### Visual Opacity

The visual observation of opacity or turbidity was done by taking 0.11 grams of spray dried powder and placing it in 5.0 grams of solvent then shaken by hand. A clear solution may indicate that material did not redisperse in a particular solvent; an opaque or turbid solution indicates redispersion occurred.

### Dynamic Light Scattering

The particle size analysis of the particles was conducted using a Horiba LB-500 Dynamic Light Scattering Analyzer. The Horiba LB-500 dynamic light scattering analyzer determines particle size through comparing the fluctuations in scattered light intensities for particles with known sizes with the measured scattered light intensities of a particular ensemble of particles, hence generating a particle size distribution curve. These time dependent fluctuations are caused by the particles in solution exhibiting Brownian motion. Brownian motion is a property of sub-micron particles in solutions. These are in a state of constant motion due to thermal interactions between them and the solvent. Smaller particles will exhibit faster motion than larger particles. The instrument has a size range of 3 nm to 6000 nm. The method is applicable to particles that can be suspended in solution. Particles that are dense and will settle out of solution cannot be analyzed via this technique.

The spray-dried silica samples were pre-dispersed in the solvent of choice by combining 0.11 g of powder with 5 g of solvent. This mixture was shaken, and then submitted for analysis. 4 drops of the pre-dispersed mixture were diluted in 2 mL of respective solvent in a plastic cuvet. The contents of the cuvet were agitated using a transfer pipet. The cuvet was then placed in the sample chamber of the Horiba LB-500 Dynamic Light Scattering Analyzer and subsequently analyzed for particle size.

A refractive index for the particles of 1.4 with an imaginary value of 0. Ii was used. Viscosity and refractive index values for the solvents (also needed for the software to calculate a particle size distribution) were obtained through literature. All data was reported in the volume mode.

### Average Particle Diameter Determination

Samples approximately 80 nm thick are placed on 200 mesh copper grids with carbon stabilized formvar substrates (SPI Supplies—a division of Structure Probe, Inc., West Chester, Pa.). A transmission electron micrograph (TEM) is taken, using JEOL 200CX (JEOL, Ltd. of Akishima, Japan and sold by JEOL USA, Inc.) at 200 Kv. A population size of about 50-100 particles can be measured and an average diameter is determined.

### Visual Opacity and Radiopacity Testing

The cured composite samples are evaluated for visual opacity and radiopacity as follows. Cured composite samples were measured for direct light transmission by measuring transmission of light through the thickness of the disk using a MacBeth transmission densitometer Model TD-903 equipped with a visible light filter, available from MacBeth (MacBeth, Newburgh, N.Y.).

For radiopacity evaluation, the procedure used followed the ISO-test procedure 4049 (1988). Specifically, cured composite samples were exposed to radiation using a Gendex GX-770 dental X-ray (Milwaukee, Wis.) unit for 0.73 seconds at 7 milliamps and 70 kV peak voltage at a distance of about 400 millimeters. The X-ray negative was developed using a Air Techniques Peri-Pro automatic film processor. (Hicksville, N.Y.).

### Crystallite Particle Size and Crystal Form Content

A liberal amount of a sample is applied by spatula to a glass microscope slide on which a section of double coated tape had been adhered and pressed into the adhesive on the tape by forcing the sample against the tape with the spatula blade. Excess sample was removed by scraping the sample area with the edge of the spatula blade, leaving a thin layer of particles adhered to the adhesive. Loosely adhered materials remaining after the scraping were removed by forcefully tapping the microscope slide against a hard surface. In a similar manner, corundum (Linde 1.0 millimicron alumina polishing powder, Lot Number C062, Union Carbide, Indianapolis, Ind.) was prepared and used to calibrate diffractometer for instrumental broadening.

X-ray diffraction scans were obtained from by use of a diffractometer employing copper Y, radiation and Inel CPS 120 (Inel Inc, Stratham, N.H.) position sensitive detector registry of the scattered radiation. The detector has a nominal angular resolution of 0.03 degrees (2.theta.) and received scattering data from 0 to 115 degree (2-theta.). The X-ray generator was operated at a setting of 40 kV and 10 mA and fixed incident beam slits were used. Data was collected for 60 minutes at a fixed take-off (incident) angle of 6 degrees. Data collections for the corundum standard were conducted on three separate areas of several individual corundum mounts. Data was collected on three separate areas of the thin layer sample mount.

Observed diffraction peaks were identified by comparison to the reference diffraction patterns contained within the ICDD powder diffraction database (sets 1-47, International Center for Diffraction Data, Newton Square, Pa.) and attributed to either cubic/tetragonal (C/T) or monoclinic (M) forms of zirconia. The amounts of each zirconia form were evaluated on a relative basis and the form of zirconia having the most intense diffraction peak was assigned the relative intensity value of 100. The strongest line of each of the remaining crystalline zirconia forms were scaled relative to the most intense line and given a value between 1 and 100.

Peak widths for the observed diffraction maxima due to corundum were measured by profile fitting. The relationship between mean corundum peak widths and corundum peak position (2 theta) was determined by fitting a polynomial to these data to produce a continuous function used to evaluate the instrumental breadth at any peak position within the corundum testing range. Peak widths for the observed diffraction maxima due to zirconia were measured by profile fitting observed diffraction peaks.

### Crystallinity Index

Particle size of the inorganic oxide is reduced by ball milling and/or hand grinding using a boron carbide mortar and pestle to pass a 325 mesh sieve. Individual mixtures were prepared consisting of 0.400 grams of sample and 0.100 grams of mass standard, a material incorporated into samples being evaluated for crystallinity index to normalize X-ray intensity values based on amount of material present in a sample. Tungsten metal powder (<3 millimicron) was the mass standard used. Mixtures of the samples were blended under ethanol using an agate mortar and pestle and allowed to dry under flowing nitrogen. A similar mixture composed of the phase standard was also prepared to serve as the crystallinity index reference. The dried mixtures were removed from the mortar and pestle by spatula and fine brush and subsequently transferred to individual sample containers. Portions of each sample were prepared as ethanol slurries on sample holders containing flush mounted glass inserts. Multiple X-ray diffraction scans (a minimum or 10 scans for both sample and standard) were obtained from each sample and phase standard mixture by use of a vertical Bragg-Bretano diffractometer (constructed by Philips Electronic Instruments, Mahwah, N.J.) employing copper K_{α} radiation, variable incident slit, fixed exit slit, graphite diffracted beam monochromator, and proportional counter registry of the scattered radiation. Scans were conducted from 25-55 degree (2-theta) employing a 0.04 degree step size. An 8 second dwell time was used for standard mixture while a 20 second dwell time was employed for sample mixtures to improve counting statistics. The X-ray generator (Spellman High Voltage Electronics Corporation, Hauppage, N.Y.) was operated at a setting of 40 kV and 20 mA. Peak areas for the observed diffraction maxima due to zirconia and tungsten phases were measured by profile fitting observed diffraction peaks within the 25-55 degree (2-theta) scattering angle range.

The X-ray scattering of internal mass standard was evaluated by measurement of cubic tungsten (110) peak area. A Pearson VII peak shape model and linear background model were employed in all cases. The profile fitting was accomplished by use of the capabilities of the JADE (version 3.1, Materials Data Inc. Livermore, Calif.) diffraction software suite.

What is claimed:

1. A method of providing a redispersible nanoparticle powder comprising:
a) providing a first dispersion of nanoparticles having surface hydroxyl groups;
b) adding a non-metal-ester molecular reactant for the hydroxyl group into the first dispersion of nanoparticles having surface hydroxyl groups;
c) reacting the reactant with the hydroxyl group to form individual, non-continuous sites having reaction product of the hydroxyl group and the reactant to form a surface treated nanoparticle; and
d) drying the surface treated nanoparticle providing a non-aggregated powder of the surface treated nanoparticles such that when the dried, treated nanoparticle powder is redispersed as a second dispersion in a carrier or solvent having affinity for the non-metal-ester reactant product, a nano-sized particle is formed.

2. The method of claim 1 wherein the dried surface-treated nanoparticle is redispersed into a solvent or carrier such that a redispersed particle size determined by dynamic light scattering or equivalent method has a volume or weight average diameter less than 1000 nm.

3. The method of claim 2 wherein a redispersion ratio (Sₚ) of less than 70 for the redispersed nano-sized particle is provided, wherein the redispersion ratio is Rₚ/Pₚ wherein Rₚ is the size of the redispersed particle and Pₚ is the size of the primary particle.

4. The method of claim 2 wherein a redispersion ratio (Sₚ) of less than 50 for the redispersed nano-sized particle is provided, wherein the redispersion ratio is Rₚ/Pₚ wherein Rₚ is the size of the redispersed particle and Pₚ is the size of the primary particle.

5. The method of claim 2 wherein a redispersion ratio (Sₚ) of less than 30 for the redispersed nano-sized particle is provided, wherein the redispersion ratio is Rₚ/Pₚ wherein Rₚ is the size of the redispersed particle and Pₚ is the size of the primary particle.

6. The method of claim 2 wherein a redispersion ratio (Sₚ) of less than 20 for the redispersed nano-sized particle is provided, wherein the redispersion ratio is Rₚ/Pₚ wherein Rₚ is the size of the redispersed particle and Pₚ is the size of the primary particle.

7. The method of claim 2 wherein a redispersion ratio (Sₚ) of less than 10 for the redispersed nano-sized particle is provided, wherein the redispersion ratio is Rₚ/Pₚ wherein Rₚ is the size of the redispersed particle and Pₚ is the size of the primary particle.

8. The method of claim 1 wherein the first dispersion of nanoparticles comprises the nanoparticles having surface hydroxyl groups within a liquid carrier.

9. The method of claim 1 wherein the drying is effected by spray drying of the dispersion.

10. The method of claim 1 wherein the reactant is selected from the group consisting of organic alcohol, organic ketones, organic acids, organic acid esters, organic acid chlorides, organic acid amides, mono-glycerides, di-glycerides, tri-glycerides, proteins, peptides, phytosterols, polysaccharides, amino acids, linseed oil, oleic acid, stearic acid, oleamide, or sugars.

11. The method of claim 1 wherein hydroxyl groups are first reacted with halogenating agents before being combined with a reagent that will react with the halogenated hydroxyl group.

12. The method of claim 11 wherein the halogenating agent comprises a halogenated silicon compound.

13. The method of claim 8 wherein the nanoparticle comprises at least one of silica, solid oxides of the metal and metalloids from groups 2-15 the 2007 International Union of Pure and Applied Chemistry (IUPAC) Periodic Table of the Elements, solid hydroxides of the metal and metalloids from groups 2-15 the 2007 International Union of Pure and Applied Chemistry (IUPAC) Periodic Table of the Elements, phosphates of the metal and metalloids from groups 2-15 the 2007 International Union of Pure and Applied Chemistry (IUPAC) Periodic Table of the Elements, sulfates of the metal and metalloids from groups 2-15 the 2007 International Union of Pure and Applied Chemistry (IUPAC) Periodic Table of the Elements, borates of the metal and metalloids from groups 2-15 the 2007 International Union of Pure and Applied Chemistry (IUPAC) Periodic Table of the Elements, oxide/hydroxide surfaces formed on carbide materials, oxide/hydroxide surfaces formed on nitride materials, metal oxides/metal hydroxides reacted onto metal oxides, or silica-coatings on carbon black.

14. The method of claim 8 wherein the nanoparticle comprises at least one of phenolic resins, polyvinyl alcohol, partially oxidized polyethylene, partially oxidized waxes, partially oxidized carbon blacks, partially oxidized carbon nano-tubes, or partially oxidized C₆₀ species.

15. The method of claim 9 wherein the nanoparticle comprises at least one of silica, solid oxides of the metal and metalloids from groups 2-15 the 2007 International Union of Pure and Applied Chemistry (IUPAC) Periodic Table of the Elements, solid hydroxides of the metal and metalloids from groups 2-15 the 2007 International Union of Pure and Applied Chemistry (IUPAC) Periodic Table of the Elements, phosphates of the metal and metalloids from groups 2-15 the 2007 International Union of Pure and Applied Chemistry (IUPAC) Periodic Table of the Elements, sulfates of the metal and metalloids from groups 2-15 the 2007 International Union of Pure and Applied Chemistry (IUPAC) Periodic Table of the Elements, borates of the metal and metalloids from groups 2-15 the 2007 International Union of Pure and Applied Chemistry (IUPAC) Periodic Table of the Elements, oxide/hydroxide surfaces formed on carbide materials, oxide/hydroxide surfaces formed on nitride materials, metal oxides/metal hydroxides reacted onto metal oxides, or silica coatings on carbon black.

16. The method of claim 9 wherein the nanoparticle comprises at least one of phenolic resins, polyvinyl alcohol, partially oxidized polyethylene, partially oxidized waxes, partially oxidized carbon blacks, partially oxidized carbon nano-tubes, or partially oxidized C₆₀ species.

17. The method of claim 10 wherein the nanoparticle comprises at least one of silica, solid oxides of the metal and metalloids from groups 2-15 the 2007 International Union of Pure and Applied Chemistry (IUPAC) Periodic Table of the Elements, solid hydroxides of the metal and metalloids from groups 2-15 the 2007 International Union of Pure and Applied Chemistry (IUPAC) Periodic Table of the Elements, phosphates of the metal and metalloids from groups 2-15 the 2007 International Union of Pure and Applied Chemistry (IUPAC) Periodic Table of the Elements, sulfates of the metal and metalloids from groups 2-15 the 2007 International Union of Pure and Applied Chemistry (IUPAC) Periodic Table of the Elements, borates of the metals from the metal and metalloids from groups 2-15 the 2007 International Union of Pure and Applied Chemistry (IUPAC) Periodic Table of the Elements, oxide/hydroxide surfaces formed on carbide materials, oxide/hydroxide surfaces formed on nitride materials, metal oxides/metal hydroxides reacted onto metal oxides, or silica coatings on carbon black.

18. The method of claim 10 wherein the nanoparticle comprises at least one of phenolic resins, polyvinyl alcohol, partially oxidized polyethylene, partially oxidized waxes, partially oxidized carbon blacks, partially oxidized carbon nano-tubes, or partially oxidized C₆₀ species.

19. The method of claim 13 wherein the nanoparticle comprises at least one of silica, alumina, titania or zirconia.

20. The method of claim 15 wherein the nanoparticle comprises at least one of silica, alumina, titania or zirconia.

21. The method of claim 17 wherein the nanoparticle comprises at least one of silica, alumina, titania or zirconia.

22. The method of claim 8 wherein the reactant is selected from the group consisting of organic alcohol, organic ketones, organic acids, organic acid esters, organic acid chlorides, organic acid amides, mono-glycerides, di-glycerides, tri-glycerides, proteins, peptides, phytosterols, polysaccharides, amino acids, linseed oil, oleic acid, stearic acid, oleamide, or sugars.

23. The method of claim 9 wherein the reactant is selected from the group consisting of organic alcohol, organic ketones, organic acids, organic acid esters, organic acid chlorides, organic acid amides, mono-glycerides, di-glycerides, tri-glycerides, proteins, peptides, phytosterols, polysaccharides, amino acids, linseed oil, oleic acid, stearic acid, oleamide, or sugars.

24. The method of claim 8 wherein reaction product extends from surfaces of the nanoparticles as individual molecular entities bound to the surfaces.

25. The method of claim 9 wherein reaction product extends from surfaces of the nanoparticles as individual molecular entities bound to the surfaces.

26. The method of claim 10 wherein reaction product extends from surfaces of the nanoparticles as individual molecular entities bound to the surfaces.

27. A dispersible free-flowing powder comprising particles comprising nanoparticles, reacted on their surface, reaction of a hydroxyl group and a reactant is selected from the group consisting of organic alcohol, organic ketones, organic acids, organic esters, and di-glycerides, the reaction product extending from surfaces of the nanoparticles as individual molecular entities bound to the surfaces and forming a discontinuous layer on the surfaces.

28. The method of claim 27 wherein the redispersion of the particles in the carrier or solvent has a particle size determined by dynamic light scattering has a volume or weight average diameter less than 1000 nm.

29. The method of claim 27 wherein a redispersion ratio (Sₚ) of less than 50 is provided, wherein the redispersion ratio is Rₚ/Pₚ wherein Rₚ is the size of the redispersed particle and Pₚ is the size of the primary particle.
